(19) United States
(12) Patent Application Publication
(10) Pub. No.: US 2009/0009300 A1
(43) Pub. Date: Jan. 8, 2009

(54) Method for Reference of an Event or Record

(76) Inventors: Carl Jarvis, Mt. Laurel, NJ (US); James Gentilin, Lumberton, NJ (US)

Correspondence Address: LICATA & TYRRELL P.C., 66 E. MAIN STREET, MARLTON, NJ, 08053, US

(21) Appl. No.: 11/997,560

(22) PCT Filed: Aug. 3, 2006
(86) PCT No.: PCT/US2006/030366

§ 371 Date: Jul. 2, 2008

Related U.S. Application Data
(60) Provisional application No. 60/705,257, filed on Aug. 3, 2005.

(51) Int. Cl. G06F 7/00

(52) U.S. Cl. 340/309.16

(57) ABSTRACT

A process to reference statically and dynamically event and record information to a device in a clear and concise manner is provided.

This patent application claims the benefit of priority from U.S. Provisional Application Ser. No. 60/705,257, filed Aug. 3, 2005, teachings of which are herein incorporated by reference in their entirety.

### FIELD OF THE INVENTION

The present invention relates to a process to reference events and record information in a clear, concise manner, inclusive of, but not limited to, reference to content, time and dates, dynamically.

### BACKGROUND OF THE INVENTION

Portable or personal systems and devices which use visual methods are often limited in text screen size, reference to medication name, output message, reminders, etc. Even systems and devices which use audible methods, which are not speech, are limited. The differentiation with speech outputs is that the content is not limited to the capability of an output method such as an LCD of 3 text lines or an audible beep. The speech output can include other information not practical within the visual output means such as drug information data including, but not limited to generic name, common uses, how to use this information, cautions, contraindications, and possible side effects. In addition, the speech content may be personalized, may include references to other medications, other information, or other conditions.

With personal information and personal health related content, the speech output may include content such as living wills, advanced directives, donor information, and other information typically found in Personal Health Information (PHI), Personal Health Records (PHR), or other similar data content databases or data files.

A wide variety of medication systems providing audible and visual alarms to a patient to indicate proper dosage time have been described.

U.S. Pat. No. 6,158,613 discloses a medication information and alarm device programmed with medication information and timing sequences for the proper administration of medication contained within the device. The device comprises a medical storage portion and a closure portion with data storage means disposed within the closure portion. The device is activated by access to the storage container and can be programmed with medication information including medication dosage, schedule, medical warnings and patient information. The device further comprises a self-contained power source with a data processing and memory chip and electronic data interface with audio data output.

U.S. Pat. No. 5,612,869 discloses an electronic health care compliance assistance system comprising a user device and a host station used by a health care provider. The user device generates voice messages to remind a user when and how to take or refill prescribed medications, to attend to other health matters and to keep doctors' appointments. Compressed digital speech is used to generate a voice message. A health care provider uses the host station to compose the message and to store a database of speech messages and related data. Data is transferred from the host station to the user device to generate a regimen that is customized for the user.

### SUMMARY OF THE INVENTION

The present invention provides a means to define the visual or audible methods used to reference the content of an event or record based on analysis of the time and date, event and record content, event structure, and/or preferences.

The visual and audible output methods used are defined by the event structure and content with variables based on selected content, modified content and calculated content based on times and dates. The output content of the event structure is also dynamic and variable based on analysis of current time and date as compared to past and future times and dates within the same event. The output methods may include visual, audible, and audible speech, where the output content may vary based on the output method used.

### DETAILED DESCRIPTION OF THE INVENTION

The present invention provides a process to define the output content of an event or record to a device for the purpose of defining the content in a clear, concise manner, inclusive of, but not limited to the output method used. The preferred embodiment refers to the output methodology regarding the audible speech output, its use, function, and derivations.

For the purpose of the present invention, by “event”, it is meant any specified type of information, which may or may not require a future action, or may or may not be set to expire at a future time and date.

By “event structure”, as used herein, it is meant any organizing attribute, as defined but no limited to, type, variables, elements, tags, or references of the event.

By “event content”, as used herein, it is meant any data, value, or coded value within the event structure.

By “record”, as used herein, it is meant an archive of an event with a specific time and date, or time/date stamp, recorded by the current time and date of the action, or entered as a past time and date. The record also refers to archived events based on past time and date up to and including the current time and date.

Devices upon which this content is output include, but are not limited to a personal device, PDA, personal computer, host computer, cell phone, or any other device capable of accepting data entry via the device itself or through a wired or wireless communication protocol. Examples of wireless communication protocols include, but are not limited to satellite, telecommunications, VoIP, voice input, user prompts, etc.

In a preferred embodiment of the present invention the event content, data, or structure relates to medical information, in particular medication administration reminders and/or lifestyle compliance.

In a preferred embodiment of the present invention, the event content or record of the event is also represented as text, or converted to text. An example of an event content based on text is the event name. An event name may consist of a medication name such as “Ibuprofen”, or it may be a reminder, appointment, meeting, anniversary, or birthday, such as “John's 50^{th} Birthday”. Including event content, the output methods used may also refer to information stored or associated with an individual, such as personal information, or personal health information. This can include content such as living wills, advanced directives, donor information or personal identifiable content such as a person's name, address and contact information, emergency contact information, or personal health information, inclusive of, but not limited to, age, weight, gender, blood type, allergies, medical conditions, medical history, or current medications used including prescription, over the counter (OTC), and herbal remedies. Visual output methods are limited in nature such that the output content, when displayed as text for the purpose of visual context, may be minimized, condensed, or restricted. In contrast, audible speech output methods are not limited by content, but may be limited on duration. The output content when speech output methods are used provides a greater capability of presenting information to the user. This is true for static information inclusive of but not limited to personal health information, such as contents of a living will, advanced directives, organ donor information, or drug information data sheets.

The present invention is not limited by the method of entering data. Any means capable of entering required data can be used. Nor is the present invention limited with respect to entering of variables and content within the event structure which allow the ability to establish records, intervals, limits, windows, and relations for the purpose of entering, calculating, or referencing future expiration dates and times based on the variables and content of the event structure and associated event structure(s). Variables and content within the event structure may or may not be manually entered and may be calculated or created using mapping techniques or standards based on, but not limited to medication SIG data, RxNorm, NCPDP, SNOMED CT, ASTM-CCR, HL7, CDA, NDC, LOINC, ICD-9-CM, or ICD-10 codes. In a preferred embodiment, the present invention relates to the use of the event content data, values, or coded values used in any form of output methodologies. An example of this is a content value of the quantity of tablets filled in a prescription, such as 30 tablets. When referencing the number of tablets for a given prescription, the user may be more interested in knowing how many tablets are left, which is a calculated value based on the number of tablets dispensed minus the number of tablets taken, verses how many tablets were dispensed. Another example is the SIG data for a given prescription which is defined within the event structure as “Directions” for which the average person would have no understanding of the terms or use, such as “1 po bid”. Therefore the output of this content in this format would be meaningless for the individual. With the present invention, however, the output of the parsed data field defined within the event structure as “Description” can include the converted SIG code as “take 1 by mouth two times a day”. Data in this format is more useful for the individual and would benefit by processing the text content.

The event or records content used in an output methodology may or may not be selected by the individual, may or may not be configured automatically, may or may not be categorized, and may be part or in whole context of the event or record. This provides a means of adding and/or deleting output content, visual or audible speech, such as, instructional, take with water, side affects, and symptoms. This also provides a means of changing the output content, visual and audible speech, such as, text strings associated with the event, and providing the ability to change the order of the output content, or the selected content of information stored within the personal information profile. An example of this is selectable content and information, such as a person's name, which may be included as the first output of all messages which gives the output message a personalized character, such as “Carl, you have an appointment today at 5:30”. This also refers to what information is presented first, and what is presented first may not be what is presented second. An example of this is an expiration of a medication which an individual deems as private or personal. When this event expires for the first time, it may say, “You have a medication reminder”, and not say the medication name. When the event is queried, the event may then say “please take the little blue pill” and still not say the medication name. These are event dependent and selectable at the event level.

For the purpose of the present invention, by “output method”, it is meant to include visual, audible, and/or audible speech as a means of outputting event content or information by use of LCD, OLED, or other means of visual displays, audible sounds not defined as speech, such as beeps, tones, or audio files, and by audible speech defined as converted text to speech, recorded text to speech, or recorded speech. Also, the output methods used, may or may not contain the same date or content. Audible speech methods may be generated by processing the whole output text string, or a parsed text string, wherein each processed parsed text string is then combined to form the whole output text string.

By “processing”, for the purpose of the present invention, it is meant a methodology of converting text to speech. The process used in converting text to speech is not limited to the language output. Current technologies allow for language conversions in many languages including, but not limited to English, Spanish, English (UK), French, German, Mandarin, and others.

In some embodiments, a method of establishing output methodologies with references to times and dates statically or dynamically may be based on analysis of the current time and date and the future time and date expiration.

The output content may provide the means of establishing directives such as, “take now”, or “take again at” or references to times and dates. For the purpose of clarity, the time and date may be categorized such as, morning, afternoon, and night. In addition, the days may be defined as today, those times within a 24 hour period, or tomorrow, those times and dates within a 2 day period, etc. The dates may also be defined as the days of the week (SMTWTFS), the months in a year (JFMAMJJASOND), or the year itself.

Further exemplary nonlimiting embodiments of the process present invention include the following:

### EXAMPLES

### Example 1

### Method of Establishing Output Methodologies which are Based on TEXT

### Example 2

### Method of Establishing Output Methodologies which are Based on Event Content, Which is based on a Static Text, or Text String

In this embodiment of the method of the present invention, the event content may or may not be selected by the individual, and may or may not be configured automatically. It may also provide a means of adding and/or deleting output content, visual and audible, such as, instructional, take with water, side affects, and symptoms; a means of changing the output content, visual and audible speech, such as, text strings associated with the event like a reference to “little blue pill”; and the ability to change the order of the output content, visual and audible speech, including content selected as output, such as a person's name.

### Example 3

### Method of Establishing Output Methodologies which References Dates and Times Statically or Dynamically which May be Based on Analysis of the Current Time and Date and the Future Time and Date Expiration (Take Now, Take Again at)

In this embodiment of the method of the present invention, a means of determining morning, afternoon, and night; a means of determining today (24) and tomorrow (48); a means of determining days of the week (SMTWTFS); a means of determining month (JFMAMJJASOND); and/or a means of determining year are provided.

### Example 4

### Method of Establishing Output Methods which May be Visual, Audible, or Audible Speech

### Example 5

### Method of Establishing Output Methodologies which Define the Output Content Based on the Output Method Used

This embodiment of the method of the present invention defines the visual content and the audible content, which may or may not be the same content. This also defines what is displayed when the event expires, or is queried, or what is said when the event expires, or is queried.

### Example 6

### Method of Establishing Output Methods Inclusive of, But not Limited to Structure, Time of Reference, Use, or Cycles

This embodiment of the method of the present invention refers to when an event first expires and you may hear the category such as “Carl, you have an urgent reminder”, which is actually a medication reminder.

### Example 7

### Method of Establishing Audible Speech Methods Which May be Generated by Processing the Whole Output Text String, or a Parsed Text String, where as Each Processed Parsed Text String is then Combined to Form the Whole Output Text String

### Example 8

### Method of Establishing Output Content for Events or Records

Exemplary nonlimiting embodiments of references for an event or record created in accordance with the process of the present invention include the following:

Exemplary Reference 1: A dynamic reference associated with times and dates for an event that has expired
you may take, 1, tablet of, Ibuprofen, now
   Exemplary Reference 2: A dynamic reference associated with times and dates for an event that will expire at a specific time and date in the future
you may take, 1, tablet of, Ibuprofen, again, tomorrow, at 8:00, in the evening
   Exemplary Reference 3: Arrangement of output content as it relates to event structure and time and date reference

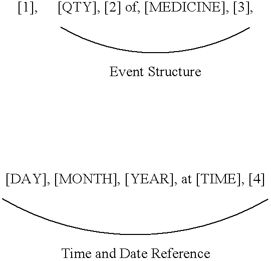

Exemplary Reference 4: Reference to an event output content
[1]
(As defined within the EVENT STRUCTURE, unbounded 0 . . . ∞)
take—if the prescription is required (or needed), or set to remind
you may take—if the prescription is as required (or as needed), or not set to remind

### [QTY]

(As defined within the EVENT CONTENT, unbounded 0 . . . ∞))
[2]
(As defined within the EVENT CONTENT, unbounded 0 . . . ∞)
tablet(s)
capsule(s)
teaspoon(s)
glass(es)
drop(s)
ounce

### [MEDICINE]

(As Defined within the Event Content, Bounded to One Instance 0 . . . ∞)
[3]
(omitted—if same as current day, unbounded 0 . . . ∞))
now
again
last
on
after
before

### [DAY]

today—if same as current day
this morning—if same as morning window
this afternoon—if same as afternoon window
this evening—if same as evening window
tomorrow—if within 24 hours of current day
SMTWTFS—if within seven days of current day

### [MONTH]

(omitted—if same as current month)

### JFMAMJJASOND

### [YEAR]

(omitted—if same as current year)

20xx

### [TIME]

(As Defined within the Event or Record Content)
[4]
(omitted—if within window morning, afternoon, or night, unbounded 0 . . . ∞)
a.m.
p.m.
in the morning (a.m.)
in the afternoon (p.m.)
in the evening (p.m.)
Exemplary Reference 5: Reference to output content

My name is John Doe. I have no medical allergies. I am taking the following medications; . . . , in case of emergency please contact Jane Doe at 555-1122.

What is claimed is:

1. A process for dynamically referencing via a visual or audible method an event or record comprising analyzing time and date, event and record content, event structure or preferences associated with an event or record; defining structure and content of the event reference based on analysis of current time and date as compared to past and future times and dates within the same event; and outputting the event or record reference to a device.

2. The process of claim 1 wherein outputting of the event or record reference is by visual, audible, or audible speech means or any combination thereof.

3. The process of claim 2 wherein said means is selected from the group consisting of an LCD, OLED, beep, tone, audio file, converted text to speech, recorded text to speech, and recorded speech, or any combination thereof.

4. The process of claim 1 wherein the event or record reference output is dependent upon the current time and date.

5. The process of claim 1 wherein the event or record reference is output to a personal device, PDA, personal computer, host computer, cell phone, or any other device capable of accepting data entry via the device itself or through a wired or wireless communication protocol.

6. The process of claim 1 wherein the event relates to medication administration or lifestyle compliance.
